(19) United States
(12) Patent Application Publication
(10) Pub. No.: US 2016/0070683 A1
(43) Pub. Date: Mar. 10, 2016

(54) ACTIVITY BASED TEXT REWRITING USING LANGUAGE GENERATION

(71) Applicant: SONY CORPORATION, Tokyo (JP)

(72) Inventor: Ola Thörn, Lund (SE)

(73) Assignee: SONY CORPORATION, Tokyo (JP)

(21) Appl. No.: 14/478,112

(22) Filed: Sep. 5, 2014

(51) Int. Cl. G06F 17/22; H04L 29/08; G06F 17/30

(52) U.S. Cl. CPC G06F 17/2288; G06F 17/30011; H04L 67/10

(57) ABSTRACT

A system and method include determining an amount of time available to a user to read a document. For example, a user device may collect sensor data about the user, identify, based on the sensor data, at least one of a location or an activity associated with the user; and determine the amount of time available to the user based on the location or the activity. A request for the document is generated, and the request includes data identifying the amount of time available to the user. The document is generated based on the amount of time available to the user and is present for display to the user. The document may be generated to include text associated with the location or the activity.

### TECHNICAL FIELD OF THE INVENTION

A disclosed implementation generally relates to a user device, such as smart telephone.

### DESCRIPTION OF RELATED ART

Natural language generation is the automatic generation of human language text (i.e., text in a human language) based on information in non-linguistic form. For example, one type of natural language generation uses template-based techniques in which portions of input data are inserted into blanks or tags in pre-defined templates. The technique may involve some type of logic to selectively include/exclude content based on an occurrence of a condition. A second type of natural language generation may use linguistics-based techniques. For example, linguistics-based techniques may use algorithms for determining concepts to include in a document and words to express the concepts.

### SUMMARY

According to one aspect, a method is provided. The method may include determining, by a processor associated with a user device, an amount of time available to a user to use a document; forwarding, by the processor, a request for the document, wherein the request includes data identifying the amount of time available to the user; receiving, by the processor and based on forwarding the request, the document, wherein the document is generated based on the amount of time available to the user; and presenting, by the processor, the document for display to the user.

In one implementation of the method, the request may further include data identifying a reading speed associated with the user, and the document may be generated based on the reading speed.

In one implementation of the method, the document includes a particular number of words, and the particular number of words may be determined based on the amount of time and the reading speed.

In one implementation of the method, determining the amount of time available to the user may include accessing scheduling information associated with the user; identifying, using the scheduling information, another activity associated with the user; and determining the amount of time available to the user based on a time period before the other activity.

In one implementation of the method, determining the amount of time available to the user to use the document may include collecting sensor data; identifying, based on the sensor data, at least one of a location or an activity associated with the user; and determining the amount of time available to the user based on the at least one of the location or the activity.

In one implementation of the method, the document is generated to include text associated with the at least one of the location or the activity.

In one implementation of the method, the sensor data may include information collected from another user device at the location, wherein the information identifies an amount of time spent by the other user device at the location.

According to one aspect, a device is provided. The device may include a memory configured to store instructions. The device may further include a processor configured to execute one or more of the instructions to determine an amount of time available to a user to use a document; forward a request for the document, wherein the request includes data identifying the amount of time available to the user; receive, based on forwarding the request, the document, wherein the document is generated based on the amount of time available to the user; and present the document for display to the user.

In one implementation of the device, the request may further include data identifying a reading speed associated with the user, and the document may be generated based on the reading speed.

In one implementation of the device, the document may include a particular number of words, and the particular number of words may be based on the amount of time and the reading speed.

In one implementation of the device, the processor, when determining the amount of time available to the user, may be further configured to execute one or more of the instructions to access scheduling information associated with the user; identify, using the scheduling information, another activity associated with the user; and determine the amount of time available to the user based on a time period before the other activity.

In one implementation of the device, the processor, when determining the amount of time available to the user, may be further configured to execute one or more of the instructions to collect sensor data; identify, based on the sensor data, at least one of a location or an activity associated with the user; and determine the amount of time available to the user based on the at least one of the location or the activity.

In one implementation of the device, the document may be generated to include text associated with the at least one of the location or the activity.

In one implementation of the device, the sensor data may include information collected from another user device at the location, wherein the information identifies an amount of time spent by the other user device at the location.

In one implementation of the device, the user device may include a mobile communications device.

According to one aspect, a non-transitory computer-readable medium is provided. The non-transitory computer-readable medium may store instructions that include one or more instructions that, when executed by a processor, cause the processor to determine an amount of time available to a user to use a document; forward a request for the document, wherein the request includes data identifying the amount of time available to the user; receive, based on forwarding the request, the document, wherein the document is generated based on the amount of time available to the user; and present the document for display to the user.

In one implementation of the non-transitory computer-readable medium, the request further may include data identifying a reading speed associated with the user, the document may be generated based on the reading speed, and the document may include a particular number of words that are selected based on the amount of time and the reading speed.

In one implementation of the non-transitory computer-readable medium, the one or more instructions to determine the amount of time available to the user may further include one or more instructions that, when executed by a processor, further cause the processor to: collect sensor data; identify, based on the sensor data, at least one of a location or an activity associated with the user; and determine the amount of time available to the user based on the at least one of the location or the activity.

In one implementation of the non-transitory computer-readable medium, the document may be generated to include text associated with the at least one of the location or the activity.

In one implementation of the non-transitory computer-readable medium, the sensor data may include information collected from another user device at the location, and the information may identify an amount of time spent by the other user device at the location.

### BRIEF DESCRIPTION OF THE DRAWINGS

FIG. 1 shows an environment in which concepts described herein may be implemented;

FIG. 2 shows exemplary components included in a user device that may be included in the environment of FIG. 1;

FIG. 3 shows exemplary components included in an augmented reality (AR) device that may correspond to the imaging device that may be included in the environment of FIG. 1;

FIG. 4 is a diagram illustrating exemplary components of a device included in the environment of FIG. 1; and

FIGS. 5-7 show flow diagrams of an exemplary processes for determining an amount of time available to a user to access (e.g., read or watch) a document and generating the document based on the available amount of time.

### DETAILED DESCRIPTION OF PREFERRED EMBODIMENTS

The following detailed description refers to the accompanying drawings. The same reference numbers in different drawings may identify the same or similar elements.

The terms “user,” “consumer,” “subscriber,” and/or “customer” may be used interchangeably. Also, the terms “user,” “consumer,” “subscriber,” and/or “customer” are intended to be broadly interpreted to include a user device or a user of a user device. The term “document,” as referred to herein, includes one or more units of digital content that may be provided to a customer. The document may include, for example, a segment of text, a defined set of graphics, a uniform resource locator (URL), a script, a program, an application or other unit of software, a media file (e.g., a movie, television content, music, etc.), or an interconnected sequence of files (e.g., hypertext transfer protocol (HTTP) live streaming (HLS) media files).

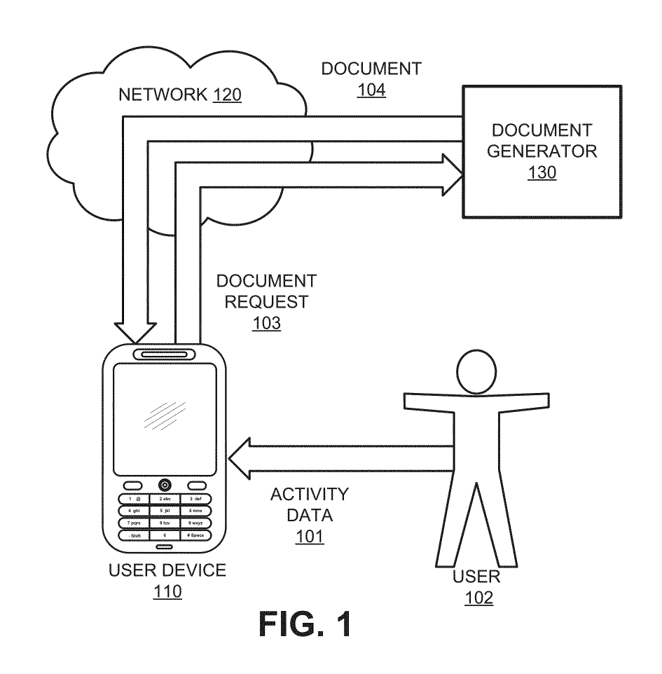

FIG. 1 shows an environment 100 in which concepts described herein may be implemented. As shown in FIG. 1, environment 100 may include a user device 110 that determines and/or collects activity data 101 of a user 102 and uses activity data 101 to generate a document request 103. In one implementation, document request 103 may include data identifying a time period when user 102 is available to view a document. User device 110 may forward document request 103, via network 120, to a document generator 130. Document generator 130 may generate a document 104 based on document request 103. For example, document generator 130 may customize document 104 to enable user 102 to view (e.g., read) document 104 completely during the available time period identified in document request 103.

User device 110 may include a device capable of determining activity data 101 and generating document request 103. User device 110 may include, for example, a portable computing and/or communications device, such as a personal digital assistant (PDA), a smart phone, a cellular phone, a laptop computer with connectivity to a cellular wireless network, a tablet computer, a wearable computer, etc. User device 110 may also include non-portable computing devices, such as a desktop computer, consumer or business appliance, set-top devices (STDs), or other devices that have the ability to connect to network 120. User device 110 may connect to network 120, for example, through a wireless radio link to obtain data and/or voice services.

User device 110 may determine activity data 101. For example, user device 110 may process calendar information associated with user 102 to identify an amount of time until a next scheduled activity and/or appointment for user 102.

In one implementation, user device 110 may include one or more sensors to detect data regarding user 102 and/or a surrounding environment. For example, user device 110 may include a location detector to identify an associated location, such as a sensor to receive a global positioning system (GPS) or other location data and/or a component to dynamically determine a location of user device 110 (e.g., by processing and triangulating data/communication signals received from base stations). Additionally or alternatively, user device 110 may include a motion sensor, such as gyroscope or accelerometer, to determine movement of user device 110. Additionally or alternatively, user device 110 may include a sensor to collect information regarding user 102 and/or the surrounding environment For example, user device 110 may include an imaging device (e.g., a camera) and/or an audio device (e.g., a microphone). Using the sensor data, user device 110 may identify an activity being performed by user 102, and estimate an amount of time available to user 102 to access document 104 based on the identified activity.

For example, if user device 110 determines that user 102 is in a coffee shop, user device 110 may estimate an amount of time that user 102 will spend in the coffee shop purchasing and/or consuming coffee. In this example, user device 110 may associate an estimated, default amount of time for visits to the coffee shop (e.g., user device may determine that the user 102 will stay ten minutes in the coffee shop). The estimated time associated with the location may be set by the user. Additionally or alternatively, user device 110 may modify the default amount of time based on user's prior visits to the coffee shop (e.g., the average amount of time spent by the user at the location during a number of prior visits). The estimated time may be further modified based on additional factors, such as the time of day, future appointments scheduled by user 102, etc.

In another implementation, user device 110 may further modify the estimated time based on data received from other devices at the determined location. In the example of user 102 being at a coffee shop, user device 110 may communicate with other user devices (not shown) located at the coffee shop to determine how long the other user devices stay at the coffee shop.

In another example, user device 110 may determine that user 102 is travelling in public transportation vehicle, such as a bus or train. For example, user device 110 may determine that the device is moving at a particular speed and/or direction associated with the public transportation vehicle. Additionally or alternatively, user device 110 may communicate with other user devices (not shown) to exchange data (e.g., location/movement information) and may determine that user 102 is moving in unison with other users associated with the other user devices. In this example, user device 110 may associate an estimated, default amount of time for travelling by public transportation. The estimated time associated with the public transportation vehicle may be set by the user and/or or may be determined based on various factors and/or data collected from other sources, such as the distance of the route traversed by the public transportation vehicle, the velocity of the public transportation vehicle, traffic conditions, etc. In one implementation, the estimated time for the user travelling in the public transportation vehicle may be modified based on a time spent by user 102 (or another user) on a prior ride on the public transportation vehicle.

In another example, user device 110 may include or interface with a sensor device, such as fitness monitor, that identifies attributes of user 102, such as the user's heart rate, body temperature, respiration rate, etc. User device 110 may use the information regarding user 102 to further identify associated activities, and user device 110 may identify possible time slots when user 102 may read document 104 based on the determined activities. For example, if user 102 has a slightly elevated heart rate and is moving at a particular velocity range, user device 110 may determine that user 102 is walking and may be available to view document 104. User device 110 may further estimate a time slot when user 102 will continue walking based on identifying an expected destination (that is, in turn, identified based on prior movements by user 102, addresses associated with contacts, etc.) and identify an amount of time it would take user 102 to walk to the destination at a current velocity.

In yet another implementation, user device 110 may generate, as activity data 101, calendar information related to user 102 based on collected sensor data. For example, user device 110 may evaluate the collected data to identify patterns in the sensor day, and user device 110 may use these identified patterns to identify time slots associated with user 102. User device 110 may then generate document request 103 to include information regarding the available time slots.

To identify the patterns in the schedule of user 102 to identify the time slots, user device 110 may use various machine learning techniques. For example, user device 110 may use regression techniques to various clustering and/or regression techniques to classify different time slots of user 102. For example, user device 102 may seek to identify time slots when user 102 stays at a geographic location, that differs from a work place or a school, for more than a threshold amount of time; when user 102 frequently requests access to document 104; etc. User device 110 may also use deep learning techniques to identify (or learn) multiple levels of representation, or a hierarchy of features, associated with time slots for user 102, with higher-level, more abstract features defined in terms of (or generating) lower-level features. For example, user device 110 may identify attributes associated with times/locations when user 102 previously accessed documents and may use these attributes to identify how long user 102 will remain at another location. In a third example, user device 110 may use machine learning techniques related to a support vector machine (SVM). For example, user device 110 may provide certain examples of locations, and user 102 may indicate whether document 104 may be requested at these locations, and how long user 102 would access document 104 at these locations. User device 110, when functioning as an SVM, may then identify common trends in the locations and the access time, and then use these trends to estimate whether other time slots/locations when user 102 would access document 104.

User device 110 may provide document request 103 to document generator 130 to request document 104. Document request 103 may include data specifying aspects of document 104. For example, document request 103 may include information identifying an amount of time (determined based on activity data 101) that user 102 has to view document 104. Document generator 130 may then generate document 104 so that document 104 characteristics (e.g., length, associated contents, etc.) that would enable user 102 to view (e.g., read) document 104 completely in the available time. In another implementation, document request 103 may specify additional information that may be considered by document generator 130 when generating document 104. For example, document request 103 may further include information regarding a reading speed/rate of user 102, such as an amount of time taken by user 102 to complete another document. In another example, document request 103 may specify types of content to exclude or include in document 104, such as audio content (and therefore can be accessed silently by user 102). In yet another example, document request 103 may specify whether user 102 is located at a library or other quiet environment. In still yet another example, document request 103 may specify other aspects of document 104, such as a resolution for presenting document 104 based on display capabilities of user device 110.

User device 110 may generate document request 103 based on receiving an input (e.g., user 102 presses certain keys or selects a portion of a touch screen) to request document 104. Alternatively, user device 110 may automatically (e.g., without receiving a user input) generate document request 103 based on determining that user 102 is available (e.g., is in a time slot) to read document 104. For example, user device 110 may automatically generate document request 103 based on determining that user 102 will remain at a particular location (e.g., a coffee shop) for at least a threshold amount of time.

Network 120 may include any network or combination of networks. In one implementation, network 120 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Alternatively or in addition, network 120 may include a content delivery network having multiple nodes that exchange data with user device 110. Although shown as a single element in FIG. 1, network 120 may include a number of separate networks that function to provide communications and/or services to user device 110.

In one implementation, network 120 may include a closed distribution network. The closed distribution network may include, for example, cable, optical fiber, satellite, or virtual private networks that restrict unauthorized alteration of contents delivered by a service provider. For example, network 120 may also include a network that distributes or makes available services, such as, for example, television services, mobile telephone services, and/or Internet services. Network 120 may be a satellite-based network and/or a terrestrial network.

Document generator 130 may include a component that generates document 104 based on data (e.g., information identifying an amount of time available to user 102 to view document 104) included in document request 103. As described above, document request 103 may further include information identifying a reading speed for user 102 and/or information specifying data to include/exclude from document 104.

To generate document 104, document generator 130 may store an original document and may modify the original document based on the data included in document request 103. For example, the original document may be designed to be read by an average user in a certain number of minutes. If document request 103 indicates that the amount of time available to user 102 is less than the expected time needed to read the original document, document generator 130 may modify to the original document to form a modified document that can be used by user 102 in less time. For example, document generator 130 may remove one or more sections of the original document, simplify the language, grammar, and/or presentation of the original document, etc., to allow user 102 to read the resulting document 104 in less time.

Conversely, if document request 103 indicates that the amount of time available to user 102 is greater than the expected time for the user to read the original document, document generator 130 may modify to the original document to generate document 104 that is longer, more complex, etc. For example, document generator 130 may modify the language, grammar, and/or presentation of the original document to cause user 102 to take more time to read the resulting document 104. Document generator 130 may add one or more sections to the original document. For example, document generator 130 may identify one or more key terms (e.g., terms that frequently appear in prominent locations) in the original document and add additional content (e.g., text, images, multimedia content) related to the key terms when generating document 104. To identify possible content to add to the original document, document generator may generate a search query and use the query to perform a search to identify relevant content on the Internet or in a data repository.

In one implementation, document generator 130 may determine the expected time to read the original document and/or generated document 104 based on statistics (e.g., the average number of words per minute) associated with an ordinary reader. Alternatively, document generator 130 may determine the expected time required to read the original document and/or generated document 104 based on data included in document request 103. For example, document request 103 may include an indication of the amount of time that user 102 takes to read other documents, and document generator 130 may use this information to determine an individualized reading speed for user 102 based on the length, complexity, etc. of the other documents. In another implementation, document generator 130 may determine different reading speeds for user 102 at different times and/or location. For example, document generator 130 may determine a first reading speed for user 102 when user 102 is in a coffee shop, and may determine a second, different reading speed for user 102 when user 102 is reading on a bus.

In one implementation, document generator 130 may dynamically create document 104 based on the data included in document request 103 (e.g., document generator 130 does not create document 104 from a template). For example, document generator 130 may use document generation software such as Yseop® or Narrative Solutions®. For example, document generator 130 may identify a target group (e.g., an educational level, age, etc.) associated with user 102 (e.g., based on the available time) and may generate document 104 based on attributes of the target group.

It should be further appreciated that although document 104 is described as being read by user 102 (e.g., that user 102 is reviewing text within document 104), document 104 may include multimedia content, such as audio and/or video content. Document generator 130 may modify multimedia content based on an available time slot associated with user 102. For example, document generator 130 may remove certain portions (e.g., remove the credits) or may otherwise modify the playtime of the multimedia content (e.g., by modifying an associated playback speed).

In another implementation, document generator 130 may further determine possible topics of interest to user 102 based on activity data 101. For example, user device 110 may process activity data 101 to identify topics of interest to user 102, and may generate document 104 to include information associated with the identified topics of interests. For example, if user 102 frequently visits a coffee shop, document 104 may include information regarding coffee.

Additionally or alternatively to modifying the content included in document 104, document generator 130 may further modify a writing style for document 104 to modify the amount of time that it would take for user 102 to read document 104. For example, document generator 130 may change the complexity of text document 104 (e.g., average number of letters per word, average number of words per sentence, etc.) to change an associated reading time. Document generator 130 may also change the grammar associated with document 104, such as to vary the sentence structure and placement of terms, modify descriptive clauses, etc. to achieve a desired reading time.

Although FIG. 1 depicts exemplary components of environment 100, in other implementations, environment 100 may include fewer components, additional components, different components, or differently arranged components than illustrated in FIG. 1. For example, user device 110 may forward document request 103, and document generator 130 may forward document 104 to a different device (such as an e-reader or other user device) for access by user 102.

Furthermore, one or more components of environment 100 may perform one or more tasks described as being performed by one or more other components of environment 100. For example, document generator 130 may be coupled to or be included as a component of user device 110 such that user device 110 obtains document 104 locally (e.g., without exchanging data via network 120). For example, document generator 130 may be an application or component residing on user device 110.

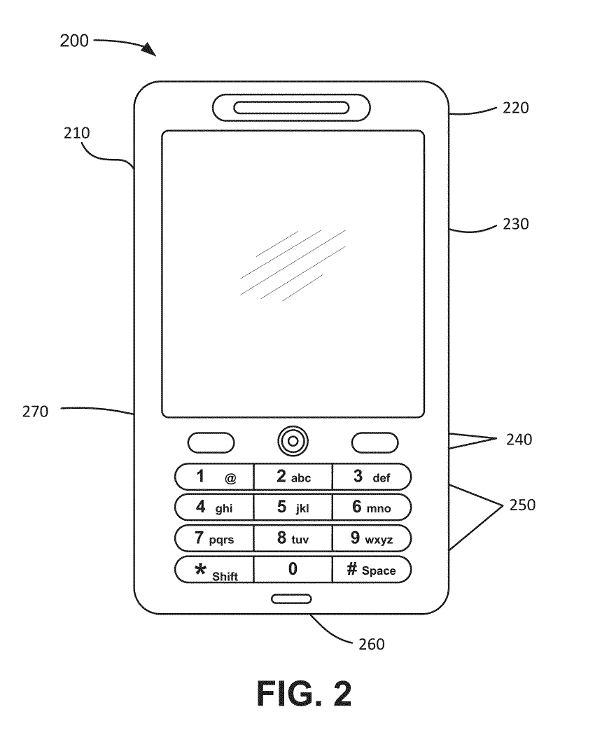

FIG. 2 shows an exemplary device 200 that may correspond to user device 110. As shown in FIG. 2, device 200 may include a housing 210, a speaker 220, a touch screen 230, control buttons 240, a keypad 250, a microphone 260, and/or a camera element 270. Housing 210 may include a chassis via which some or all of the components of device 200 are mechanically secured and/or covered. Speaker 220 may include a component to receive input electrical signals from device 200 and transmit audio output signals, which communicate audible information to a user of device 200.

Touch screen 230 may include a component to receive input electrical signals and present a visual output in the form of text, images, videos and/or combinations of text, images, and/or videos which communicate visual information to the user of device 200. In one implementation, touch screen 230 may display text input into device 200, text, images, and/or video received from another device, and/or information regarding incoming or outgoing calls or text messages, emails, media, games, phone books, address books, the current time, etc.

Touch screen 230 may also include a component to permit data and control commands to be inputted into device 200 via touch screen 230. For example, touch screen 230 may include a pressure sensor to detect touch for inputting content to touch screen 230. Alternatively or in addition, a capacitive or field sensor to detect touch.

Control buttons 240 may include one or more buttons that accept, as input, mechanical pressure from the user (e.g., the user presses a control button or combinations of control buttons) and send electrical signals to a processor (not shown) that may cause device 200 to perform one or more operations. For example, control buttons 240 may be used to cause device 200 to transmit information. Keypad 250 may include a standard telephone keypad or another arrangement of keys.

Microphone 260 may include a component to receive audible information from the user and send, as output, an electrical signal that may be stored by device 200, transmitted to another user device, or cause the device to perform one or more operations. Camera element 270 may be provided on a front or back side of device 200, and may include a component to receive, as input, analog optical signals and send, as output, a digital image or video that can be, for example, viewed on touch screen 230, stored in the memory of device 200, discarded and/or transmitted to another device 200.

In one implementation, camera element 270 may capture images of user 102, when user 102 is reading a document, to identify a reading speed of user 102 reading the document. Reading speeds for different portions of the document may be identified based on correlating a reading speed during a time period (e.g., a minute) with a portion of the document being presented on touch screen 230 or another display during that time period.

Although FIG. 2 depicts exemplary components of device 200, in other implementations, device 200 may include fewer components, additional components, different components, or differently arranged components than illustrated in FIG. 2. Furthermore, one or more components of device 200 may perform one or more tasks described as being performed by one or more other components of device 200.

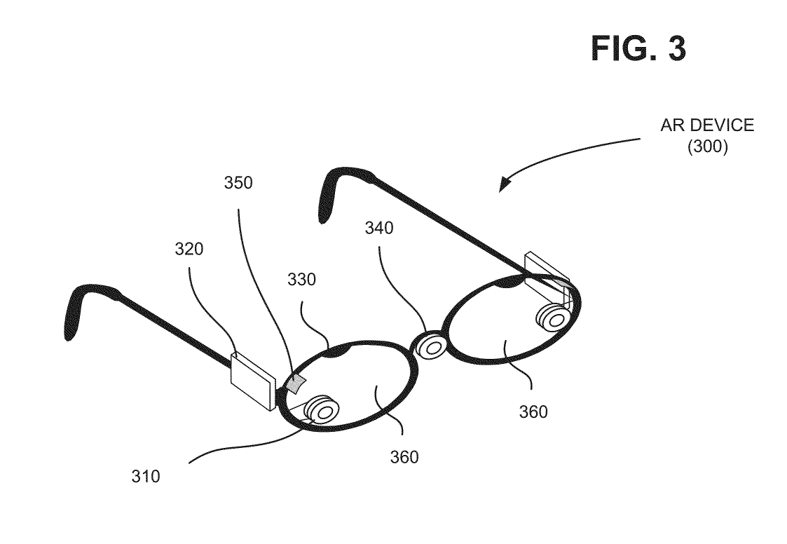

FIG. 3 shows exemplary components that may be included in an augmented reality (AR) device 300 that may correspond to user device 110 or is connected to user device 110 in one implementation. AR device 300 may correspond, for example, to a head-mounted display (HMD) that includes a display device paired to a headset, such as a harness or helmet. HMDs place images of both the physical world and virtual objects over the user's field of view. AR device 300 may also correspond to AR eyeglasses. For example, AR device 300 may include eye wear that employ cameras to intercept the real world view and re-display an augmented view through the eye pieces and devices in which the AR imagery is projected through or reflected off the surfaces of the eye wear lens pieces.

As shown in FIG. 3, AR device 300 may include, for example, a depth sensing camera 310, sensors 320, eye camera(s) 330, front camera 340, projector(s) 350, and lenses 360. Depth sensing camera 310 and sensors 320 may collect depth, position, and orientation information of objects viewed by a user in the physical world. For example, depth sensing camera 310 (also referred to as a “depth camera”) may detect distances of objects relative to AR device 300. Sensors 320 may include any types of sensors used to provide information to AR device 300. Sensors 320 may include, for example, motion sensors (e.g., an accelerometer), rotation sensors (e.g., a gyroscope), and/or magnetic field sensors (e.g., a magnetometer).

Continuing with FIG. 3, eye cameras 330 may track eye movement to determine the direction in which the user is looking in the physical world. Front camera 340 may capture images (e.g., color/texture images) from surroundings, and projectors 350 may provide images and/or data to be viewed by the user in addition to the physical world viewed through lenses 360.

In operation, AR device 300 may capture images (e.g., activate eye cameras 330 user 102 is viewing document 104 and/or activate front camera 340 to collect information regarding a surrounding environment). For example, AR device 300 (or another device) may use data collected from eye cameras 330 to identify a time period when user 102 is viewing document 104 and use this information identify user's 102 reading speed or rate. In a second example, AR device 300 (or another device) may use data collected from eye cameras 330 to identify amounts of time that user 102 views different portions of a document. Document generate 130 may use this information when generating/modifying document 104 to achieve a desired reading time for user 102 or another, different user.

Although FIG. 3 depicts exemplary components of AR device 300, in other implementations, AR device 300 may include fewer components, additional components, different components, or differently arranged components than illustrated in FIG. 3. Furthermore, one or more components of AR device 300 may perform one or more tasks described as being performed by one or more other components of AR device 300.

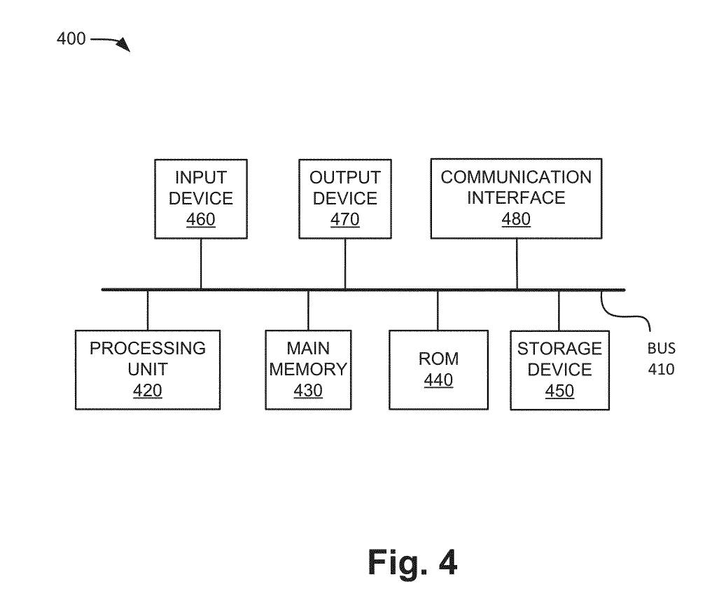

FIG. 4 is a diagram of exemplary components of a device 400 that may correspond to one or more devices of environment 100, such as device 200. As illustrated, device 400 may include a bus 410, a processing unit 420, a main memory 430, a ROM 440, a storage device 450, an input device 460, an output device 470, and/or a communication interface 480. Bus 410 may include a path that permits communication among the components of device 400.

Processing unit 420 may include one or more processors, microprocessors, or other types of processing units that may interpret and execute instructions. Main memory 430 may include a RAM or another type of dynamic storage device that may store information and instructions for execution by processing unit 420. ROM 440 may include a ROM device or another type of static storage device that may store static information and/or instructions for use by processing unit 420. Storage device 450 may include a magnetic and/or optical recording medium and its corresponding drive.

Input device 460 may include a mechanism that permits an operator to input information to device 400, such as a keyboard, a mouse, a pen, a microphone, voice recognition and/or biometric mechanisms, etc. Output device 470 may include a mechanism that outputs information to the operator, including a display, a printer, a speaker, etc.

Communication interface 480 may include any transceiver-like mechanism that enables device 400 to communicate with other devices and/or systems. For example, communication interface 480 may include mechanisms for communicating with another device or system via network 120. For example, if user device 110 is a wireless device, such as a smart phone, communication interface 480 may include, for example, a transmitter that may convert baseband signals from processing unit 420 to radio frequency (RF) signals and/or a receiver that may convert RF signals to baseband signals. Alternatively, communication interface 480 may include a transceiver to perform functions of both a transmitter and a receiver. Communication interface 480 may further include an antenna assembly for transmission and/or reception of the RF signals, and the antenna assembly may include one or more antennas to transmit and/or receive RF signals over the air.

As described herein, device 400 may perform certain operations in response to processing unit 420 executing software instructions contained in a computer-readable medium, such as main memory 430. A computer-readable medium may be defined as a non-transitory memory device. A memory device may include space within a single physical memory device or spread across multiple physical memory devices. The software instructions may be read into main memory 430 from another computer-readable medium or from another device via communication interface 480. The software instructions contained in main memory 430 may cause processing unit 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of device 400, in other implementations, device 400 may include fewer components, different components, differently arranged components, or additional components than those depicted in FIG. 4. Alternatively, or additionally, one or more components of device 400 may perform one or more other tasks described as being performed by one or more other components of device 400.

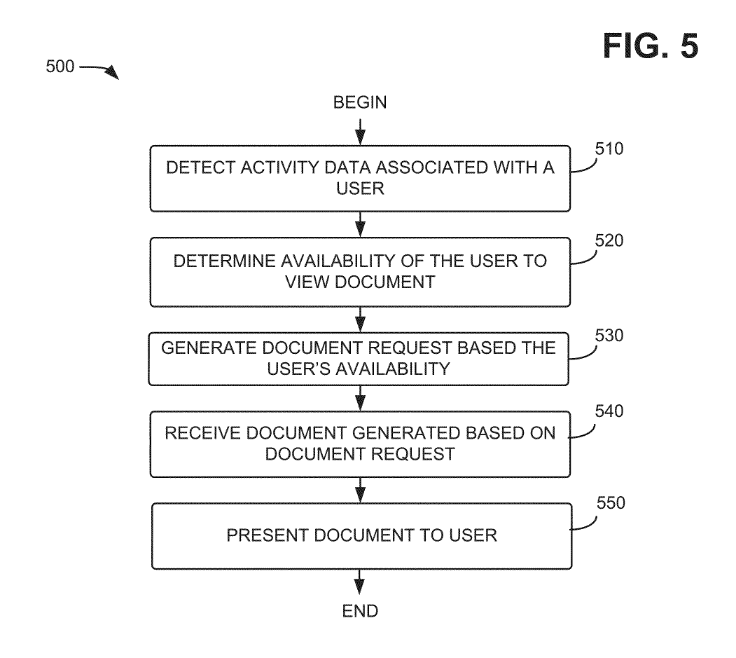

FIG. 5 is a flow chart of an exemplary process 500 for determining an amount of time available to user 102 to access (e.g., read or watch) document 104 and generating document 104 based on this available amount of time. In one exemplary implementation, process 500 may be performed by user device 110. In another exemplary implementation, some or all of process 500 may be performed by a device or collection of devices separate from, or in combination with user device 110, such as in combination with document generator 130.

As shown in FIG. 5, process 500 may include user device 110 determining activity data 101 (block 510). For example, user device 110 may process calendar information associated with user 102 to identify an amount of time until a next scheduled activity and/or appointment for user 102. Additionally or alternatively, user device 110 may include one or more sensors to detect data regarding user 102 and/or a surrounding environment. For example, user device 110 may detect when user 102 goes into a site (e.g., is present at a particular GPS location associated with the site), and records how much time user 102 spends at the site (e.g., when user device 110 is present at a location that differs from the particular GPS location associated with the site). In another implementation, user device 110 may further modify the estimated time based on data received from other devices at the determined location.

As shown in FIG. 5, process 500 may further include user device 110 generating document request 103 and forwarding the document request 103 to document generator 130 (block 520). Document request 103 may request document 104 from document generator 130. For example, document request 103 may be a uniform resource identifier (URI) associated with document 104. Document request 103 may include data specifying desired aspects of document 104. For example, user device 110 may append one or more extensions to the URI identifying the desired aspects (e.g., a desired length) of document 104. For example, if user 102 reads 120 words per minute, and user 102 has 10 minutes available to read document 104, document generator 130 may form document 104 to include 10×120, or 1200 words. For example, document request 103 may include information identifying an amount of time (determined based on activity data 101) that user 102 has to review (e.g., read) document 104 and information regarding a reading speed/rate of user 102, such as an amount of time taken by user 102 to read another document. In another example, document request 103 may specify types of content to include or exclude in document 104, such as audio content (and therefore can be accessed silently by user 102) if user 102 is located at a library or other quiet environment.

Continuing with process 500 in FIG. 5, document generator 130 may then generate document 104 (block 530) so that document 104 has resulting characteristics (e.g., length, associated contents, etc.) that would enable user 102 to read/view document 104 in the available time. For example, if document request 103 includes a request for a document having 1200 words, document generator 130 may modify an original document to include the requested quantity (e.g., 1200) of words.

As shown in FIG. 5, process 500 may also include user device 110 receiving document 104 from document generator 130 (block 540) and presenting the document to user 102 (block 550).

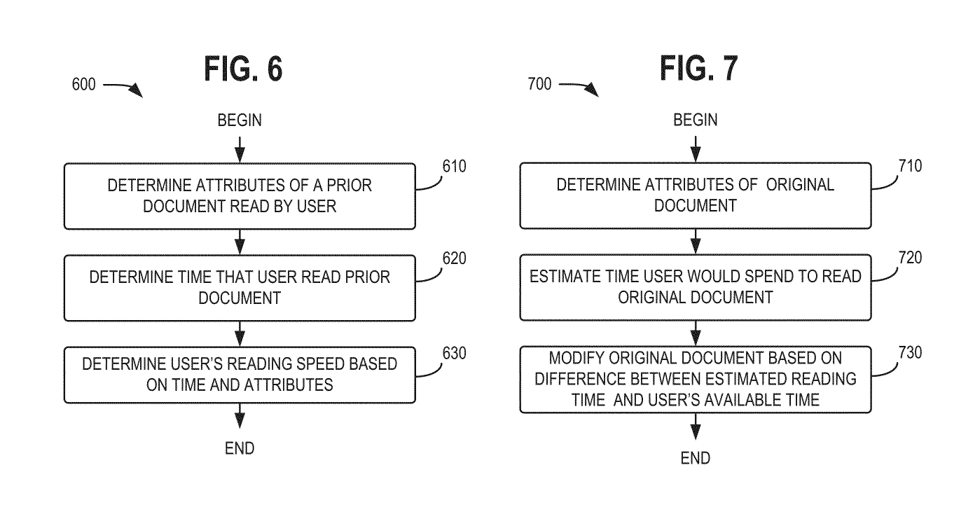

FIG. 6 is a flow chart of an exemplary process for determining a reading speed associated with user 102. As described with respect to process 500, document generator 130 may use the reading speed when generating document 104. In one exemplary implementation, process 600 may be performed by user device 110. In another exemplary implementation, some or all of process 600 may be performed by a device or collection of devices separate from, or in combination with user device 110, such as in combination with document generator 130.

As shown in FIG. 6, process 600 may include determining attributes of another document previously read by user 102 (block 610). For example, user device 110 may determine a length, complexity, etc. of the other document. User device 110 may further determine an amount of time used by user 102 to read the other document (block 620). For example, user device 110 may determine an amount of time that the other document is displayed to user 102 by user device 110. In one implementation, user device 110 may determine an amount of time that user 102 is actually viewing the other document. For example, user device 110 may include an optical sensor, such as a camera, to monitor movement of user's 102 eyes or otherwise determine that user 102 is accessing the other document.

As shown in FIG. 6, process 600 may further include determining user's 102 reading speed based on the document length and the amount of time that user 102 read the other document (block 630). For example, if the document is 1000 words long and was read for five minutes (e.g., before user 102 accessed a different document), user's 102 reading speed may be calculated as 1000÷5, or 200 words per minute. User device 110 may further adjust the determined reading speed based other attributes of the prior-read document. For example, user's 102 reading speed may be increased if document is complex (e.g., uses relatively difficult language and/or grammar) and, therefore, may be more difficult to read. For example, the complexity of a document may be determined based on the number of words in the document, the average length of the words, the average number of words per sentence, the average number of sentences per paragraph, etc. In one implementation, document generator 130 may determine different reading speeds for user 102 at different times and/or location.

In another implementation, determining the reading speed in block 630 may include modifying the calculated reading speed value based on an activity or location associated with user. For example, if user 102 is reading while engaged in an activity, such as walking, that may require some concentration or if user 102 is reading while at a location that is busy (e.g., a location where many other user devices are present) or distracting (e.g., user device 110 detects noise above a certain decibel level via a microphone), the calculated reading speed value may be increased to adjust for the possible distractions to user 102.

In yet another implementation, user device 110 may differentiate between how a layout, quantity of images, charts, types of images, etc. affects the reading speed in block 630. For example, user device 110 (e.g., using camera element 270 and/or eye camera 330) may track user's 102 eyeballs to determine an amount of time that user 102 spends in various sections of document, such as the amount of time that user 102 views an image or a chart.

In one implementation, process 600 may be repeated with respect to document 104 for user 102 or for another user. For example, user's 102 calculated reading speed value may be updated based on an amount of time that user 102 accessed document 104 and based on attributes (e.g., length, complexity, etc.) of document 104.

FIG. 7 is a flow chart of an exemplary process for generating document 104. In one exemplary implementation, process 700 may be performed by document generator 130. In another exemplary implementation, some or all of process 700 may be performed by a device or collection of devices separate from, or in combination with document generator 130, such as in combination with user device 110.

As shown in FIG. 7, process 700 may include document generator 130 acquiring an original document and determining attributes of the original document (block 710). For example, document generator 130 may determine a length (e.g., number of words) associated the original document. Document generator 130 may further determine a complexity of the original document. For example, document generator may determine the average length (e.g., number of letters) of words, number of words used in sentences in the original document, number of sentences used in paragraphs, etc.

As shown in FIG. 7, process 700 may further include estimating an amount of time that it would take user 102 to read the original document (block 720). For example, document generator 130 may use the calculated reading speed, determined in process 600, to estimate a reading time for the original document based on its length. Document generator 130 may further modify the estimated reading time based on other attributes of the original document, such as its complexity. In one implementation, document generator may present the original document to users and may monitor amounts of time that the other users took to read the original document.

Continuing with process 700 in FIG. 7, document generator 130 may modify the original document based on difference between the estimated reading time and user's 102 availability (e.g., as identified in document request 103). For example, if the amount of time available to user 102 is less than the expected time needed to read the original document, document generator 130 may modify to the original document to form a shorter, modified document that can be used (e.g., viewed, read, etc.) by user 102 in less time. Conversely, if the amount of time available to user 102 is more than the expected time needed to read the original document, document generator 130 may modify to the original document to form a longer document.

In one example, document generator 130 may use the information regarding how different sections, images, layouts, charts, etc. influence user's 102 reading speed. For example, document generator 130 may modify a layout (e.g., to change the position of images, charts, page breaks, text size, etc.) of the original document to achieve a desired reading time. For example, if user 102 takes some time to view certain types of images (e.g., images of certain size colors, content, etc.), document generator 130 may add that type of images when generating document 104 that is longer to read or may remove this type of images to generate document 104 that user 102 can read in a shorter time.

While a series of blocks has been described with regard to processes 500, 600, and 700 shown in FIGS. 5-7, the order of the blocks may be modified in other implementations. Further, non-dependent blocks may be performed in parallel. In another implementation, it should be appreciated that processes 500, 600, and/or 700 may include additional blocks and/or one or more of blocks may be modified to include additional/less actions.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code--it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms “comprises” and “comprising,” when used in this specification, are taken to specify the presence of stated features, integers, steps or components but do not preclude the presence or addition of one or more other features, integers, steps, components or groups thereof.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
determining, by a processor associated with a user device, an amount of time available to a user to use a document;
forwarding, by the processor, a request for the document, wherein the request includes data identifying the amount of time available to the user;
receiving, by the processor and based on forwarding the request, the document, wherein the document is generated based on the amount of time available to the user; and
presenting, by the processor, the document for display to the user.

2. The method of claim 1, wherein the request further includes data identifying a reading speed associated with the user, and wherein the document is generated based on the reading speed.

3. The method of claim 2, wherein the document includes a particular number of words, wherein the particular number of words is based on the amount of time and the reading speed.

4. The method of claim 1, wherein determining the amount of time available to the user includes:
accessing scheduling information associated with the user;
identifying, using the scheduling information, another activity associated with the user; and
determining the amount of time available to the user based on a time period before the other activity.

5. The method of claim 1, wherein determining the amount of time available to the user to use the document includes:
collecting sensor data;
identifying, based on the sensor data, at least one of a location or an activity associated with the user; and
determining the amount of time available to the user based on the at least one of the location or the activity.

6. The method of claim 5, wherein the document is generated to include text associated with the at least one of the location or the activity.

7. The method of claim 6, wherein the sensor data includes information collected from another user device at the location, wherein the information identifies time spent by the other user device at the location.

8. A device comprising:
a memory configured to store instructions; and
a processor configured to execute one or more of the instructions to:
determine an amount of time available to a user to use a document;
forward a request for the document, wherein the request includes data identifying the amount of time available to the user;
receive, based on forwarding the request, the document, wherein the document is generated based on the amount of time available to the user; and
present the document for display to the user.

9. The device of claim 8, wherein the request further includes data identifying a reading speed associated with the user, and wherein the document is generated based on the reading speed.

10. The device of claim 9, wherein the document includes a particular number of words, wherein the particular number of words is based on the amount of time and the reading speed.

11. The device of claim 8, wherein the processor, when determining the amount of time available to the user, is further configured to execute one or more of the instructions to:
access scheduling information associated with the user;
identify, using the scheduling information, another activity associated with the user; and
determine the amount of time available to the user based on a time period before the other activity.

12. The device of claim 8, wherein the processor, when determining the amount of time available to the user, is further configured to execute one or more of the instructions to:
collect sensor data;
identify, based on the sensor data, at least one of a location or an activity associated with the user; and
determine the amount of time available to the user based on the at least one of the location or the activity.

13. The device of claim 12, wherein the document is generated to include text associated with the at least one of the location or the activity.

14. The device of claim 13, wherein the sensor data includes information collected from another user device at the location, wherein the information identifies time spent by the other user device at the location.

15. The device of claim 14, wherein the user device includes a mobile communications device.

16. A non-transitory computer-readable medium to store instructions, the instructions including:
one or more instructions that, when executed by a processor, cause the processor to:
determine an amount of time available to a user to use a document;
forward a request for the document, wherein the request includes data identifying the amount of time available to the user;
receive, based on forwarding the request, the document, wherein the document is generated based on the amount of time available to the user; and
present the document for display to the user.

17. The non-transitory computer-readable medium of claim 16, wherein the request further includes data identifying a reading speed associated with the user, wherein the document is generated based on the reading speed, and wherein the document includes a particular number of words that are selected based on the amount of time and the reading speed.

18. The non-transitory computer-readable medium of claim 16, wherein the one or more instructions to determine the amount of time available to the user further include:
one or more instructions that, when executed by the processor, further cause the processor to:
collect sensor data;
identify, based on the sensor data, at least one of a location or an activity associated with the user; and
determine the amount of time available to the user based on the at least one of the location or the activity.

19. The non-transitory computer-readable medium of claim 18, wherein the document is generated to include text associated with the at least one of the location or the activity.

20. The non-transitory computer-readable medium of claim 18, wherein the sensor data includes information collected from another user device at the location, wherein the information identifies time spent by the other user device at the location.
